(19) United States
(12) Patent Application Publication
(10) Pub. No.: US 2014/0028246 A1
(43) Pub. Date: Jan. 30, 2014

(54) PRINTER WITH BATTERY CHARGED VIA USB PORT

(71) Applicants: Lech Martynowski, Ekeren (BE); Jimmy Dullaert, Stekene (BE); Jos Vleurinck, Oordegem (BE)

(72) Inventors: Lech Martynowski, Ekeren (BE); Jimmy Dullaert, Stekene (BE); Jos Vleurinck, Oordegem (BE)

(21) Appl. No.: 13/881,494

(22) PCT Filed: Oct. 28, 2011
(86) PCT No.: PCT/EP11/69061

§ 371 Date: Oct. 15, 2013

(30) Foreign Application Priority Data
Oct. 29, 2010 (GB) 1018303.6

(51) Int. Cl. H02J 7/00

(52) U.S. Cl. CPC H02J 7/007
USPC 320/107; 320/137; 320/145

(57) ABSTRACT

Apparatus comprises measuring circuitry configured to determine a current provided by a USB port, a controller configured to select a charging current in dependence on the determined current, and a battery charger configured to charge a battery with said selected current.

The present invention relates to an apparatus and method and in particular and not exclusively to a printer comprising a rechargeable battery or battery pack and a method of charging. The printer may be a label printer.

Reference is made to US 2006/0164447 which discloses an Ethernet and USB (Universal Serial Bus) powered printing device. To support high speed and/or data intensive printing operations, the printer is provided with a power storage device such as a rechargeable battery that is able to be charged during non-printing periods and provide for energy bursts to support higher powered processes, when the printer is powered by the Ethernet or USB connection. The USB powering can be used to provide power for printing and backup of data.

U.S. Pat. No. 6,357,011 discloses a printer which is powered via the USB connection. A rechargeable battery is provided which supplements the USB power provided during active periods. When the printer is not printing, the rechargeable battery is recharged via the USB connection.

PC connectable label printers are known. Using these label printers, users can create and print labels via an interface on a PC. The label printers may print on discrete labels or on a continuous length of tape which can be cut to the desired size.

According to one aspect, there is provided a method comprising: determining information relating to a current provided by a USB port; selecting a charging current in dependence on the determined information; and charging a battery with said selected current.

According to another aspect, there is provided apparatus comprising: means for determining information relating to a current provided by a USB port; means for selecting a charging current in dependence on the determined information; and means for charging a battery with said selected current.

According to another aspect there is provided apparatus comprising: measuring circuitry configured to determine a current provided by a USB port; a controller configured to select a charging current in dependence on the determined current; and a battery charger configured to charge a battery with said selected current.

Some embodiments will now be described by way of example only and with reference to the accompanying drawings in which:

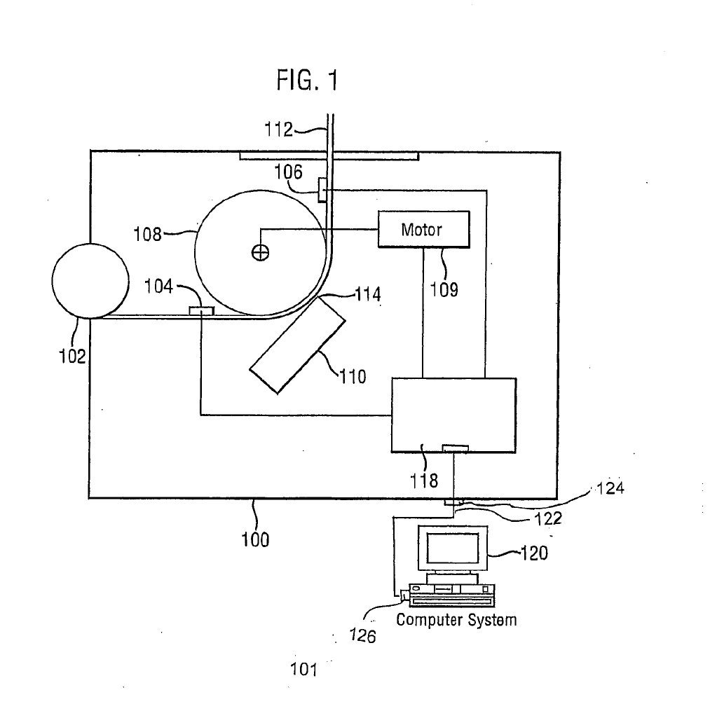

FIG. 1 shows a schematic view of a label printer;

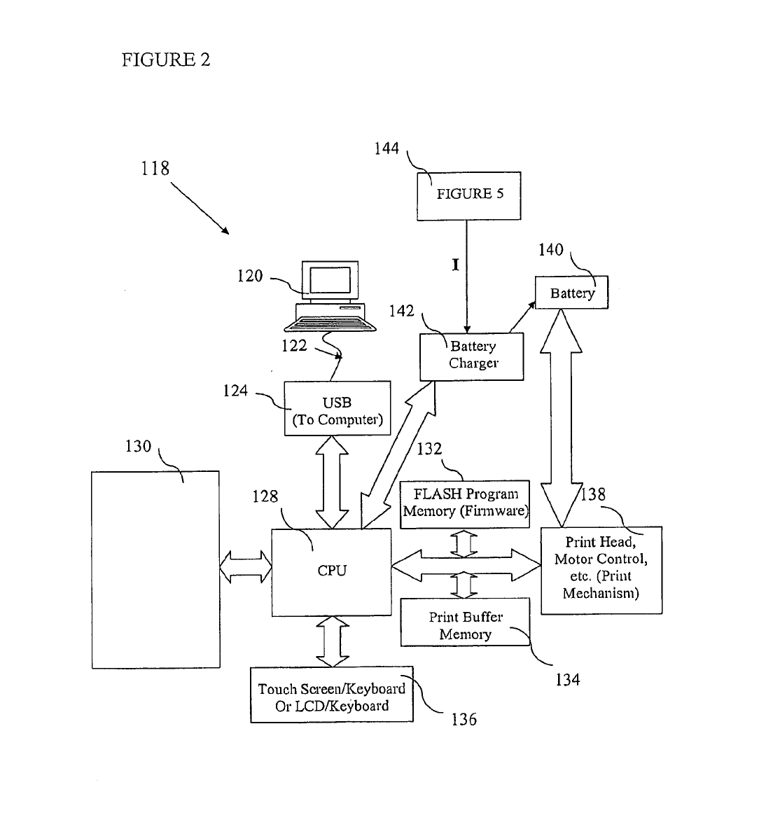

FIG. 2 shows the control elements of the label printer of FIG. 1 in more detail;

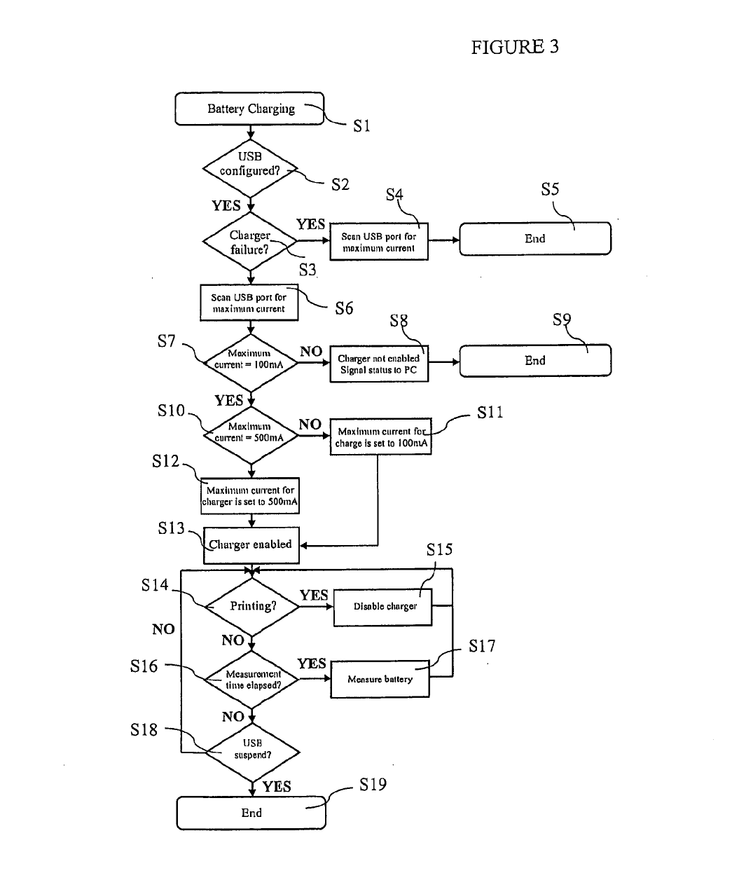

FIG. 3 shows a battery charging method for the label printer of FIG. 1;

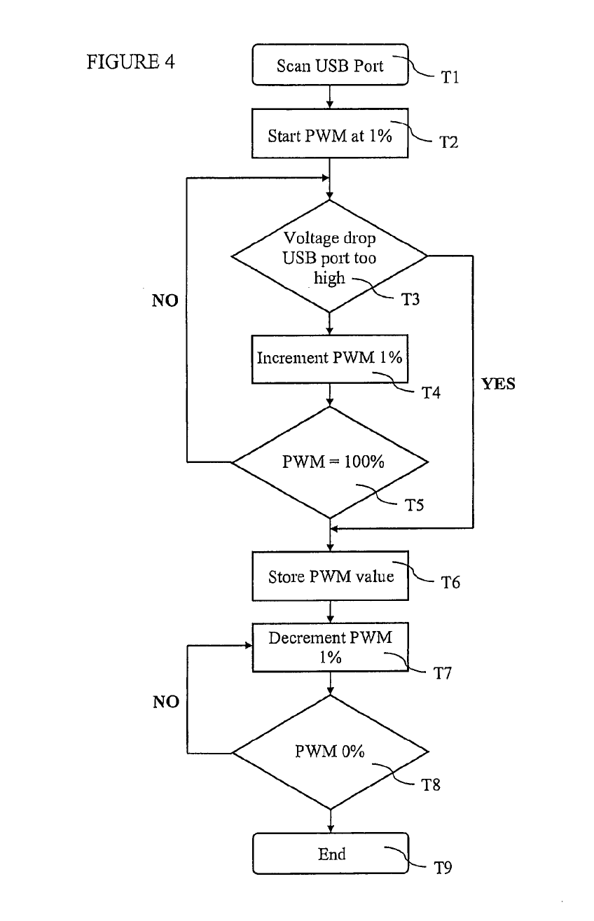

FIG. 4 shows a flow diagram of a method of scanning a USB port;

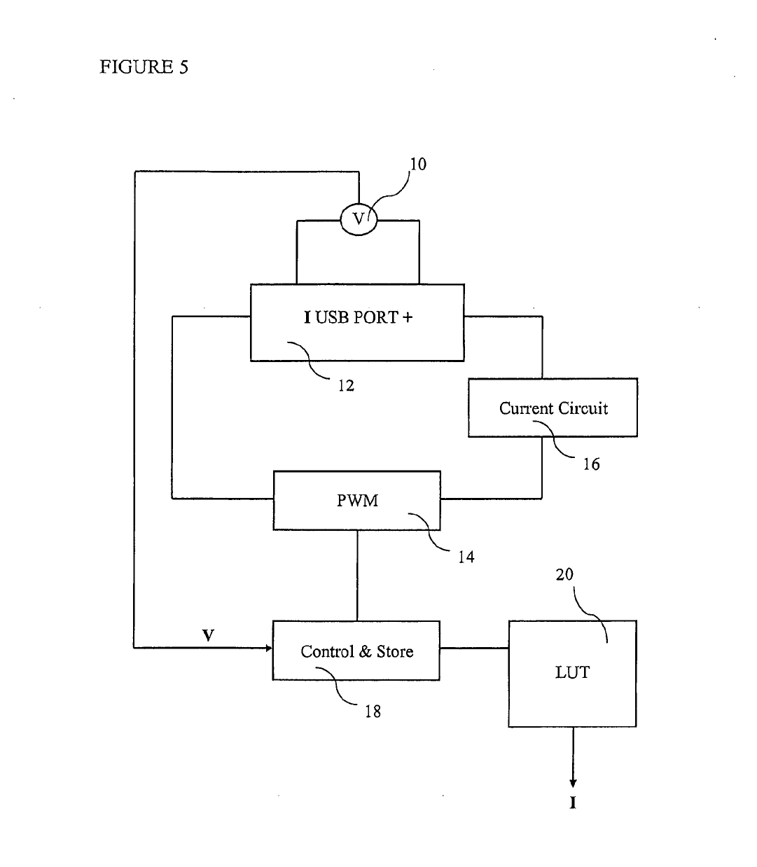

FIG. 5 shows circuitry associated with the scanning of the USB port; and

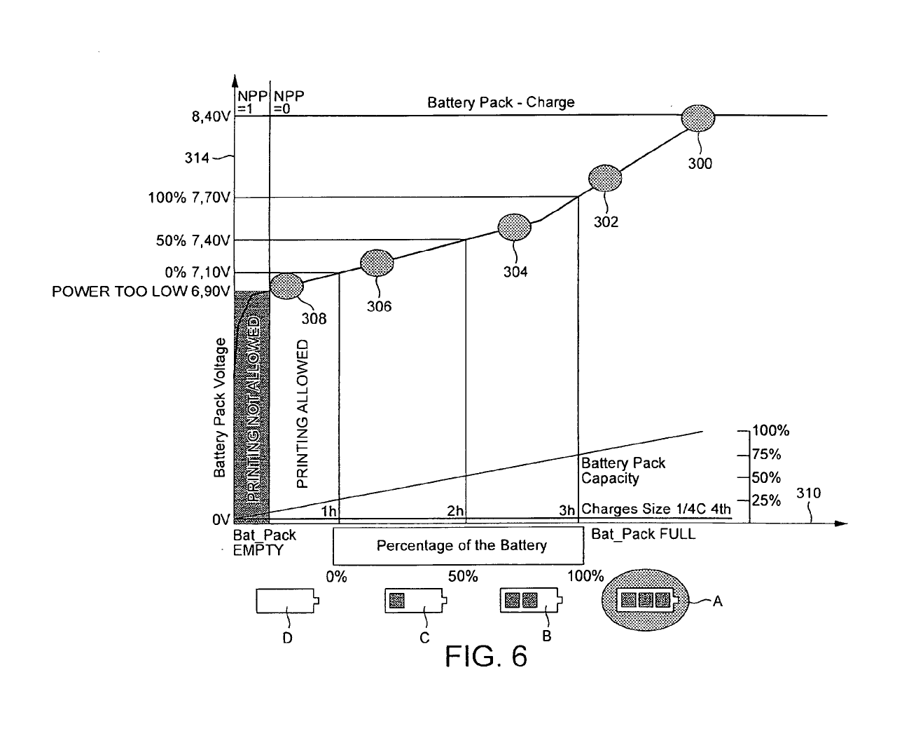

FIG. 6 shows a graph of a battery pack discharge curve and battery level indicator.

FIG. 1 illustrates a logical view of a label printing system 101. The label printing system 101 includes a label printer shown schematically at 100 and a personal computer (PC) 120.

The label printer 100 accepts label stock 102 and prints information onto labels of the label stock 102.

The label stock 102 includes labels and a stock carrier material. The labels are adhered to the stock carrier material in a manner generally known in the art.

Alternatively the label stock may comprise a supply of continuous tape comprising a backing layer and a print receiving layer. Such continuous tape is cut to a desired length using a cutting mechanism shown schematically at 106. Some printers may be able to print on both labels on a carrier and continuous tape. Other printers may only be able to print on either labels on a carrier or a continuous tape.

In this embodiment the label printer 100 includes a top of form (hereinafter “TOF”) sensor 104, a platen 108, a motor 109, a print head 110, and an exit point 112, and hardware 118. The hardware 118 is described in more detail below with respect to FIG. 2.

The TOF sensor 104 detects TOF marks (not shown) and the presence or absence of the label stock 102.

It should be appreciated that the TOF sensor is optional and may be omitted. Some embodiments may be alternatively or additionally used with continuous tape which may not have TOF marks. Some embodiments may be arranged to print on continuous tape only and the TOF sensor may be omitted. It should be appreciated that some embodiments which use discrete labels, those discrete labels may not have TOF marks associated therewith. In these embodiments the TOF sensor may be omitted.

The motor 109 drives the platen 108, such that the platen 108 turns in a clockwise or counter-clockwise direction. Rotation of the platen 108 causes the label stock 102 to advance in a forward direction if the platen 108 rotates counter-clockwise or to advance in a reverse direction if the platen 108 rotates in a clockwise direction.

The print head 110 prints information onto the label stock 102. The print head 110 is positioned such that the information is printed at a pinch-point 114 of the platen 108 and the print head 110.

The printer 100 is connected to the PC 120 via a USB cable 122 which plugs into a USB port 124 of the label printer and USB port 126 of the PC 120.

Via this USB connection the label printer 100 can send information to the PC 120 regarding the types of labels contained on the label stock 102, or where the label stock is continuous tape, the width of that tape. The label printer 100 can also send information on whether or not the label printer 100 is ready to print, a battery level status and the like. This information allows the PC 120 to format print requests for the label printer 100.

Likewise the PC 120 is capable of sending information to the label printer 100 via a USB cable 122, such as print data, firmware updates, and the like.

As will be described in more detail, the USB connection is also used to charge a battery or battery pack of the label printer from the PC or a USB adapter

The interaction between the label printer 100 and PC 120 is described in further detail below.

In one embodiment, the label stock 102 may be contained within a cartridge or case. Use of a cartridge or case containing the label stock 102 allows a user to insert and/or remove labels from the label printer 100 with ease. Once the cartridge or case is inserted into the label printer 100, the label printer 100 begins processing the label stock from the cartridge or case. The label stock 102 is processed through the label printer 100 in substantially the same manner as if the label stock 102 was not contained within the cartridge or case. In alternative embodiments of the invention, the label stock can be provided in a form of a label roll which is received in the label printer, without the presence of a casing or cartridge.

The printer hardware 118 is shown in more detail in FIG. 2.

The printer hardware 118 comprises a central processing unit (CPU) 128, Flash storage 130 (used for a mass storage device function), Flash program memory 132, print buffer memory 134, data entry unit 136 and print mechanism 138.

In the Flash program memory 132 the printer firmware is stored. The Flash program memory can be provided inside or outside the central processing unit or any other suitable microcontroller.

Print buffer memory 134 temporarily stores queued print data. Once print data in the buffer memory 134 has been printed, it is cleared from the buffer.

The print mechanism is shown generally at 138. The print mechanism 138 includes print head 110 and motor 109 (see FIG. 1).

As well as being able to enter data via PC 120, a user can enter data (such as alpha-numeric data) using data entry unit 136 which is located on the label printer 100. The data entry unit 136 may comprise a keyboard, and/or a touch-screen. The data entry may comprise a display. However, in some embodiments, label data can be provided from an external source such a PC or a memory stick or the like.

As can be seen from FIG. 2, a battery 140 (or battery pack) is provided. The battery 140 is a rechargeable battery or any other suitable rechargeable power source. The term battery is used cover battery, battery pack or any other type of battery arrangement. The battery may in fact comprise a number of batteries. The rechargeable battery 140 is arranged to be charged by a battery charger 142. The charging current used by the battery charger is controlled by the output of block 144 which is shown in FIG. 5 and will be discussed in more detail later. The battery charger 142 is connected to the CPU to receive control information therefrom.

As can be shown schematically, the battery 140 is used to control the thermal printing and as such provides the power for the print head, motor etc. This battery may be the sole source of power or may augment power provided via the USB connection or the like.

In some embodiments, the thermal print head needs to have a voltage higher than the voltage supplied by the USB port in order to print. Further, the current needed for thermal printing may be higher than the current available from the USB port. To that end, a battery may be used for printing. This battery is generally a rechargeable battery and can be charged from the USB port. A USB device i.e. a USB printer can request a certain amount of current but currently, it will not be known whether or not the USB port of the PC is able to supply the required current. Currently, devices which are charged via the USB port only require the voltage of USB port and not a higher voltage. Further, generally such known devices are within the maximum current than the USB port can supply. Some embodiments, which are now described, address this.

Reference is now made to FIG. 3. In step 51, the battery is in a battery charging state. In other words, the printer is such that the battery can be charged. In some embodiments, the battery is only charged when the printer is not printing or is another mode where power is being consumed or significantly consumed.

In step S2, a determination is made as to whether or not the printer is in a USB configuration.

If the printer is in the USB configuration, the next step is S3 where a determination is made as to whether or not there is a charger failure. If there is a charger failure, the next step is step S4 where the printer signals the charging error status to the PC. This is followed by step S5 where the battery charging process is ended.

If it is determined that there is no battery charging failure, then the USB port is scanned for its maximum current, in step S6. This is described in more detail with reference to FIGS. 4 and 5

In step S7, it is determined if the maximum current is greater than 100 mA. If the maximum current is not greater than 100 mA i.e. is less than 100 mA, then the next step is step S8 where the charger is not enabled and this status is signalled to the PC. In other words, the PC is advised that the battery is not being charged. This may be accompanied by an indication that the current is not high enough. This latter indication may be sent as an alternative indication to the PC. Of course any additional or alternative messaging may be provided to the PC in response to a determination that the maximum current provided by the USB port is insufficient for charging. Step S8 is following by step S9 which ends the battery charging process.

If it is determined that the maximum current supplied by the USB port is greater than 100 mA, then a determination is made as to whether or not maximum current is at the 500 mA level. If not, the next step is step S11 where the maximum current for the charger is set to 100 mA. This is followed by step S13 where the charger is enabled.

If on the other hand, it is determined that the maximum current is at the 500 mA level, then the next step is step S12 where the maximum current for the charger is set to 500 mA. Step S12 is also followed by step S13 where the charger is enabled.

In some embodiments, the 100 mA and 500 mA values are from the USB specification. Normally a USB port can supply 500 mA in a configured state. Some USB hubs and USB ports do not follow the USB specifications. So the 100 mA may be used for USB unconfigured states and 500 mA may be used for the USB configured states if the USB port is able to supply this 500 mA.

When the device is connected to the PC through the USB port, the device presents the PC with possible configurations. A device can have multiple configurations and supplies these to the PC, the PC then picks one the configurations. Once the PC has selected a configuration, the device is in configured state. When in a configured state the device will appear in the device manager of the PC.

It should be appreciated that in some embodiments, different charging currents may be used. For example the USB specification may be updated to include one or more different current values to those mentioned above. This may be additional or alternative current values. Additionally or alternatively, new devices provided to market may be arranged to provide different currents from USB ports which may be used alternatively or additionally in some embodiments.

In some embodiments, an arrangement may be used where a determination is made of the current provided by the USB port and this determined value is used as a charging current. There may be minimum and/or maximum charging current set.

After step S13, a check is made in step S14 to see if there is a printing operation being requested. If so, the next step is step S15 in which the charging operation is disabled. Step S15 is followed by step S14.

If it is determined in step S14 that there is no printing operation requested or about to start, or even currently on-going, the next step is step S16 in which it is determined whether the measurement time has elapsed. This represents the intervals at which the voltage of the battery is measured. If this period has elapsed, the next step is step S17 where the voltage of the battery is measured.

If the determination is in S16 is that it is not time to make another voltage measurement of the battery, then the next step is step S18 where it is determined if the USB mode has been suspended. If it has, then the USB charging is ended in step S19. If not, the next step is again step S14.

Reference is made to FIG. 6 which shows a battery pack discharge curve 312 which is plot of voltage against how full the charged battery is. Starting from the state where there is a full battery, this is referenced 300 on the battery discharge curve 312, the user starts to print labels. The battery indication referenced A is displayed (on the PC, the label printer or both) which shows the battery is fully charged. In this embodiment, three battery bars out of three are shown.

Reference is now made to the state referenced 302 on the battery pack discharge curve. The user continues to print labels and although voltage is decreasing, the battery pack voltage is still full and the battery indication referenced A is displayed.

Reference is now made to the state referenced 304 on the battery pack discharge curve. The user continues to print labels and the battery pack voltage is decreasing. In this case the battery indication referenced B is displayed. In this battery indication, two battery bars out of three are shown. Part of the battery capacity has now been consumed. This contrast with the state referenced 302 where no battery capacity had been consumed.

Reference is now made to the state referenced 306 on the battery pack discharge curve. The user continues to print labels and the battery pack voltage is decreasing. In this case the battery indication referenced C is displayed. In this battery indication, one battery bar out of three is shown. Most of the battery capacity has now been consumed. The user will understand that most of the battery capacity has been consumed and that he should consider recharging.

Reference in now made to the state referenced 308 on the battery pack discharge curve. The user continues to print labels and the battery pack voltage is decreasing. In this case the battery indication referenced D is displayed. In this battery indication, no battery bars out of three are shown. Most if not all of the battery capacity has now been consumed. The user will understand that the battery capacity has been consumed and that the battery needs recharging. The user may still be able to print a final label(s) but the print quality may in some cases be degraded.

Reference in now made to the state referenced 310 on the battery pack discharge curve. The user attempts to print labels. In this case the battery indication referenced D is displayed. In this battery indication, no battery bars out of three are shown. The user will no longer be able to print. A message indicating to the user that the battery needs to be recharged will be displayed on the label printer, PC or both. The message can be a text message or other indication such as the battery icon flashing or any other suitable message.

It should be appreciated that three battery bars may be displayed when the battery level is 100%, when two bars are displayed the battery level is between 51-99%, when one bar is displayed the battery level is 1-50% and when no bar is displayed the battery is empty. It should be appreciated that the number of bars used can be changed to be more or less than three bars. The battery levels represented by the bars can of course be changed.

Information may be provided to the user via an icon, message or the like indicating if charging is possible or if the battery is being charged. This may be provided in conjunction with the battery level indicator or separately thereform. Information may also or alternatively be provided to indicate if the printer is disconnected.

Thus if the voltage of the battery drops below the voltage of the USB, there may be a situation where the battery does not supply enough current, the remaining current could drawn from the USB port and this current is most likely higher than 500 mA. This would damage the USB port. To avoid this, when the battery voltage falls below the USB voltage no printing is allowed. These checks are in the printing cycle.

It should be appreciated that any one or more of the messages mentioned may be shown in the application running on the PC. The application may be a label editor application.

With the arrangement of FIG. 3, where no error is found with the charging circuit, the scanning process is started on the USB port. This will check how much the current the USB port can deliver. This may provide a safety measure and a control which allows any USB port to be used. The USB port that can be used with the label printer may be from a PC, a USB hub or any other dedicated device with a USB port. This is described in more detail with reference to FIGS. 4 and 5.

Reference is first made to FIG. 4 which shows a scanning method. In step T1, the USB port is scanned. In step T2, a pulse width modulated signal is applied to a current circuit. This circuit draws more current as the pulse width modulation duty cycle increases. In step T2, the pulse width modulation duty cycle is started at 1%. This duty cycle is expressed in percentage terms with 0% being fully off and 100% being fully on. A duty cycle of 1% means that the power is off 99% of the time and on 1% of the time.

In step T3, a check is made to see if the USB port voltage has dropped below a predetermined value. This may be determined by measuring the voltage across the USB port or by determining the amount by which the voltage has dropped as compared to one or more previous measurements. If the voltage drop across the USB port is above a certain value, or put another way the USB voltage has dropped below a predetermined value across the port, then the next step is step T6. Step T6 will be described in more detail later. If it is determined that the voltage drop across the USB port is not too high, then the pulse width modulated signal duty cycle is increased by 1%. In step T5 it is determined whether the pulse width modulated signal duty cycle is equal to 100%. If yes, then the next step is T6. If not, the next step is again step T3.

The value of the duty cycle at the point at which the current circuit starts drawing current such that there is a significant or predefined voltage drop across the USB port indicates the current which is provided by the USB port.

In step T6, the pulse width modulation duty cycle value is stored. In step T7, the duty cycle of the pulse width modulated signal is decreased by 1%. In step T8, it is determined whether the pulse width modulation signal duty cycle is 0%. If not, the next step is again T7. If on the other hand the pulse width modulation signal duty cycle is 0% then the next step is step T9 which ends the process.

The gradual transition of the duty cycle of the pulse width modulated signal down to 0% creates a smooth transition from the checking current on the USB port and enables the charger.

The stored PWM value is compared to predetermined values which results in the decision as to whether or not charging is carried out with 100 mA, 500 mA or no current at all. If it is not possible to draw at least 100 mA from the USB port, the printer will not start charging and an error message is reported to the PC. If the current value is lower than 500 mA, then the charger will charge the battery with 100 mA. As described in relation to FIG. 3, once the charging current is determined, the battery charger is enabled and the current flows from the USB port into the battery. When printing is enabled the charging will be disabled and the battery supplies the current needed for thermal printing. It should be appreciated that the battery may supply all of the current required for thermal printing or may be used to supplement the current which is available from the USB port.

When the printing has ended, the charging of the battery will commence again.

During printing, the battery voltage is checked and if the battery voltage falls below a certain voltage, the printing is stopped and the status is signalled to the PC. The charge on the battery is periodically checked and the charging is controlled correspondingly.

When the battery voltage falls below a certain value, information is made available to the PC indicating that there is insufficient power to print or that there is no battery present. In the absence of a battery, charging will be disabled and the device will connect from the USB port. This is accord with the USB specification for USB charged devices. It should be appreciated that the same mechanism for absence of battery can also be used for failure of battery.

It is possible in some embodiments to charge the battery of the printer using a USB adapter. These USB adapters do not put the device into USB configured state. In order to detect the situation, a predetermined time is waited. If the device is not configured within this time, it is determined that a wall adapter is being used to power the printer. Thus, the USB device can be charged with the USB adapter.

This specific status (the printer being charged by a USB adapter) may be signalled to the user by generating a specific indication sequence for a LED (Light Emitted Diode) or providing any other suitable information. An USB adapter generally supplies 500 mA without any problem, while an USB port current can be uncertain. As such, it may be possible to charge the battery quicker with a USB adapter. Charging with higher currents may be possible. The upper current may not be limited to 500 mA but may be higher, for example up to 1 A, resulting in shorter charging time.

Reference is made to FIG. 5 which schematically shows part of the circuitry for implementing the arrangement of the method of FIG. 4.

Reference is made to FIG. 5. The USB port 12 effectively acts as a voltage supply. The voltage provided across the USB port 12 is measured by appropriate circuitry referenced 10. Attached across the USB port in series is a pulse width modulator circuit 14 and a current circuit 16. A control and store circuitry 18 is configured to control the duty cycle of the pulse width modulating signal provided by circuit 14. Additionally, the control and store circuitry is configured to store the pulse width modulating value of step T6 of FIG. 4. The output of the voltage circuitry 10 is input to the control and store circuitry 18. In response to this voltage value, the control and store circuitry 18 is arranged to effectively perform the steps shown in FIG. 4 and uses the voltage information provided from the voltage measurement circuitry 10. The stored PWM value of step T6 is used as an address for a lookup table 20. The value at the looked up address of the look up table will correspond to the charging current to be used. The value the charging current to be used 20 is output by the lookup table.

In some embodiments, current measurement may be used to check battery charging. In alternative embodiments a Coulomb meter or the like may be used to measure the current that flows in a certain time. This may be more accurate in some embodiments.

The skilled person would appreciate that any of the methods described herein may be implemented using a computer program embodied on a computer readable medium (such as a CDROM or memory within the printer) for controlling a controller (or other similar apparatus as discussed above).

The methods shown in the Figures may be performed by one or more processing units in conjunction with for example one or more memories. The methods may be implemented by a computer program running on one or more processing units. The one or more processing units may be the CPU and/or any other suitable controller. The computer program itself may be provided in one or more memories which may any one or more of the memories such as shown in FIG. 2 and/or any other memory.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within scope of the invention, as defined by the claims.

1. A method comprising:
determining information relating to a current provided by a USB port;
selecting a charging current in dependence on the determined information; and
charging a battery with said selected current and a prohibiting printing if a voltage of said battery falls below a voltage of said USB port.

2. (canceled)

3. A method as claimed in claim 1, comprising determining a duty cycle value of a pulse width modulated signal applied to a current circuit is such that a voltage drop across the USB port is indicative of the current provided by the USB port and using said duty cycle value to select said charging current.

4. A method as claimed in claim 1, comprising repeatedly applying a pulse width modulated signal to a current circuit, first successively increasing the duty cycle of the pulse width modulated signal, until a voltage drop across the USB port is indicative of the current provided by said USB port and then successively decreasing the duty cycle of the pulse width modulated signal.

5. A method as claimed in claim 1, wherein said determining comprises applying a pulse width modulated signal to a current circuit, and wherein said determining comprises determining a voltage across the USB port, and changing a duty cycle of the pulse width modulate signal to determine a duty cycle value at which the voltage across the USB port satisfies a condition, wherein said condition comprises the voltage falling below a value.

6-7. (canceled)

8. A method as claimed in claim 4, comprising increasing said duty cycle of the pulse width modulated signal until the voltage across the USB port satisfies said condition, and decreasing said duty cycle of the pulse width modulated signal after the voltage across the USB port satisfies said condition.

9-10. (canceled)

11. A method as claimed in claim 4, comprising increasing said duty cycle of the pulse width modulation signal until the voltage falls below said value.

12-13. (canceled)

14. A method as claimed in claim 1, comprising determining if a maximum current of said USB port is greater than a first value, and preventing charging of said battery if said maximum current is less than first said value.

15. (canceled)

16. A method as claimed in claim 7, comprising determining if a maximum current of said USB port is a second value, said second value being greater than said first value and one of: selecting said second value as said selected current if available; and selecting said first value as said selected current if said maximum current is less than said second value.

17. (canceled)

18. Computer program product comprising code embodied on a computer-readable medium and being configured so as when executed on a processor to perform operations of:
determining information relating to a current provided by a USB port;
selecting a charging current in dependence on the determined information; and
charging a battery with said selected current.

19. Apparatus comprising:
measuring circuitry configured to determine a current provided by a USB port;
a controller configured to select a charging current in dependence on the determined information;
a battery charger configured to charge a battery with said selected current; and a printing mechanism, said controller configured to prohibit said printing mechanism from printing if a voltage of said battery falls below a voltage of a USB port.

20. (canceled)

21. Apparatus as claimed in claim 10, wherein said measuring circuitry is arranged to determine a duty cycle value of a pulse width modulated signal applied to a current circuit is such that a voltage drop across the USB port is indicative of the current provided by the USB port and said controller is configured to use the duty cycle value to select said charging current.

22. Apparatus as claimed in claim 10, wherein said measuring circuitry is arranged to repeatedly apply a pulse width modulated signal to a current circuit, first successively increasing the duty cycle of the pulse width modulated signal, until a voltage drop across the USB port is indicative of the current provided by said USB port and then successively decrease the duty cycle of the pulse width modulated signal.

23. Apparatus as claimed in claim 9, wherein said measuring circuitry is configured to apply a pulse width modulated signal to a current circuit, and wherein said measuring circuitry is configured to determine a voltage across the USB port, and wherein said measuring circuitry is configured to change a duty cycle of the pulse width modulated signal to determine a duty cycle value at which the voltage across the USB port satisfies a condition, wherein said condition comprises the voltage falling below a value.

24-25. (canceled)

26. Apparatus as claimed in claim 13, wherein said measuring circuitry is configured to increase said duty cycle of the pulse width modulated signal until the voltage across the USB port satisfies said condition, and wherein said measuring circuitry is configured to decrease said duty cycle of the pulse width modulated signal after the voltage across the USB port satisfies said condition.

27-28. (canceled)

29. Apparatus as claimed in claim 14, wherein said measuring circuitry is configured to increase said duty cycle of the pulse width modulated signal until the voltage falls below said value.

30. Apparatus as claimed in claim 14, wherein said selecting means is configured to use said duty cycle value when said voltage across the USB port satisfies said condition to select said charging current.

31. (canceled)

32. Apparatus as claimed in claim 9, wherein said measuring circuitry is configured to determine if a maximum current of said USB port is greater than a first value, and to prevent charging of said battery if said maximum current is less than said first value.

33. (canceled)

34. Apparatus as claimed in claim 17, wherein said measuring circuitry is configured to determine if a maximum current of said USB port is a second value, said second value being greater than said first value.

35. Apparatus as claimed in claim 18, wherein said controller is configured to select one of: said second value as said selected current if available; and said first value as said selected current if said maximum current is less than said second value.

36. (canceled)

37. A printer comprising an apparatus as claimed in claim 10.
